(19) United States
(12) Patent Application Publication
(10) Pub. No.: US 2025/0229544 A1
(43) Pub. Date: Jul. 17, 2025

(54) SHEET DRYING APPARATUS AND IMAGE FORMING SYSTEM PROVIDED THEREWITH

(71) Applicant: KYOCERA Document Solutions Inc., Osaka (JP)

(72) Inventors: Mitsuhiro GODA, Osaka (JP); Masaki MURASHIMA, Osaka (JP); Minoru TOKONAMI, Osaka (JP); Hiroyuki UEDA, Osaka (JP); Hisaji KAWAI, Osaka (JP); Shinya MATSUI, Osaka (JP); Koji IKAWA, Osaka (JP); Hironori YAMAUCHI, Osaka (JP)

(73) Assignee: KYOCERA Document Solutions Inc., Osaka (JP)

(21) Appl. No.: 19/017,130

(22) Filed: Jan. 10, 2025

(30) Foreign Application Priority Data
Jan. 17, 2024 (JP) 2024-005590

(51) Int. Cl. B41J 11/00; B41J 29/377

(52) U.S. Cl. CPC B41J 11/00212; B41J 11/00216; B41J 11/0022; B41J 11/0085; B41J 29/377

(57) ABSTRACT

A sheet drying apparatus includes a conveyance portion, a drying portion, a heater voltage power supply, and a control portion. The conveyance portion conveys a sheet having an image formed on it with ink containing moisture. The drying portion has a heater arranged opposite the conveyance portion and heats and dries the sheet by using the heater. The heater voltage power supply applies an alternating-current voltage to the heater. The control portion controls the heater voltage power supply. The control portion can change the duty of the alternating-current voltage applied to the heater from an initial set value to an adjusted set value.

### INCORPORATION BY REFERENCE

This application is based on and claims the benefit of priority from Japanese Patent Application No. 2024-005590 filed on Jan. 17, 2024, the contents of which are hereby incorporated by reference.

### BACKGROUND

The present disclosure relates to a sheet drying apparatus that dries sheets on which images have been printed in an inkjet recording apparatus or the like, and to an image forming system provided with such a sheet drying apparatus.

As recording apparatuses such as facsimile machines, copiers, and printers, inkjet recording apparatuses, which form images by ejecting ink onto a sheet, are widely used. Sheet drying apparatuses are known for heating and drying sheets (paper) on which ink has been adhered by inkjet recording apparatuses.

On a sheet drying apparatus that dries sheets by using an infrared heater, the drying performance (the radiation intensity of infrared rays) necessary to sufficiently dry different kinds of sheet varies with the amount of ink adhered to the sheets per unit area. Specifically, as the amount of ink per unit area increases, the drying performance (the radiation intensity of the heater) needs to be increased.

With conventional configurations, the heater can be switched only between on and off and this does not allow fine setting of radiation illuminance in accordance with the sheets as the target of drying. Thus, a change of ink, or particular kinds of sheet, do not allow optimal setting and requires extensive work such as replacement of heaters.

### SUMMARY

According to one aspect of the present disclosure, a sheet drying apparatus includes a conveyance portion, a drying portion, a heater voltage power supply, and a control portion. The conveyance portion conveys a sheet having an image formed on it with ink containing moisture. The drying portion includes a heater arranged opposite the conveyance portion, and heats and dries the sheet by using the heater. The heater voltage power supply applies an alternating-current voltage to the heater. The control portion controls the heater voltage power supply. The control portion can change the duty of the alternating-current voltage applied to the heater from an initial set value to an adjusted set value.

### BRIEF DESCRIPTION OF THE DRAWINGS

FIG. 1 is a schematic diagram showing the internal construction of an image forming system provided with a sheet drying apparatus according to the present disclosure.

FIG. 2 is a side sectional view around a drying portion in the sheet drying apparatus according to one embodiment of the present disclosure.

FIG. 3 is an enlarged view of the drying portion in FIG. 2.

FIG. 4 is a block diagram showing one example of control paths in the sheet drying apparatus.

FIGS. 5A to 5C are schematic diagrams showing examples of setting the duty of the waveform of an alternating-current voltage applied to a heater.

FIG. 6 is a flow chart showing an example of control for changing the duty of the heater in the drying portion.

### DETAILED DESCRIPTION

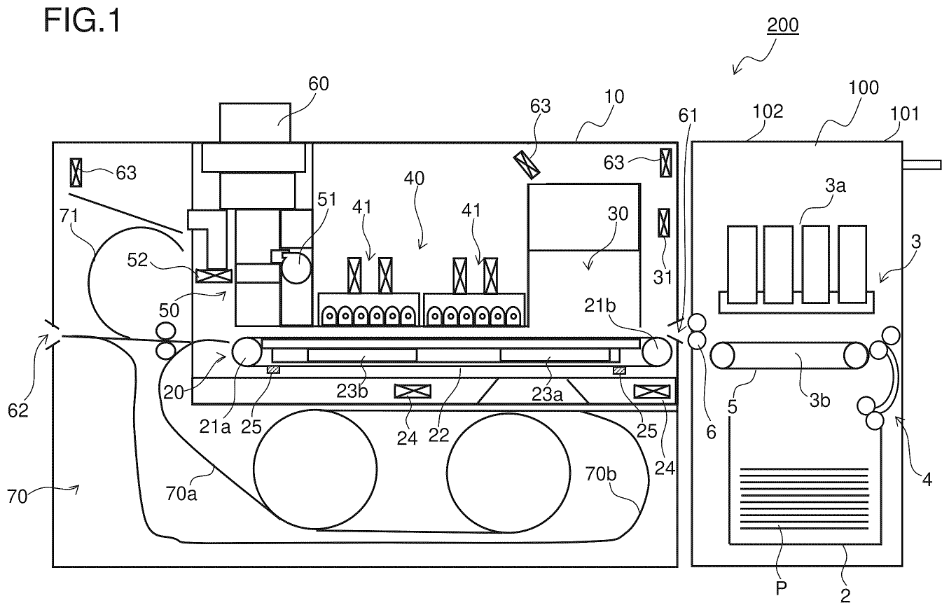

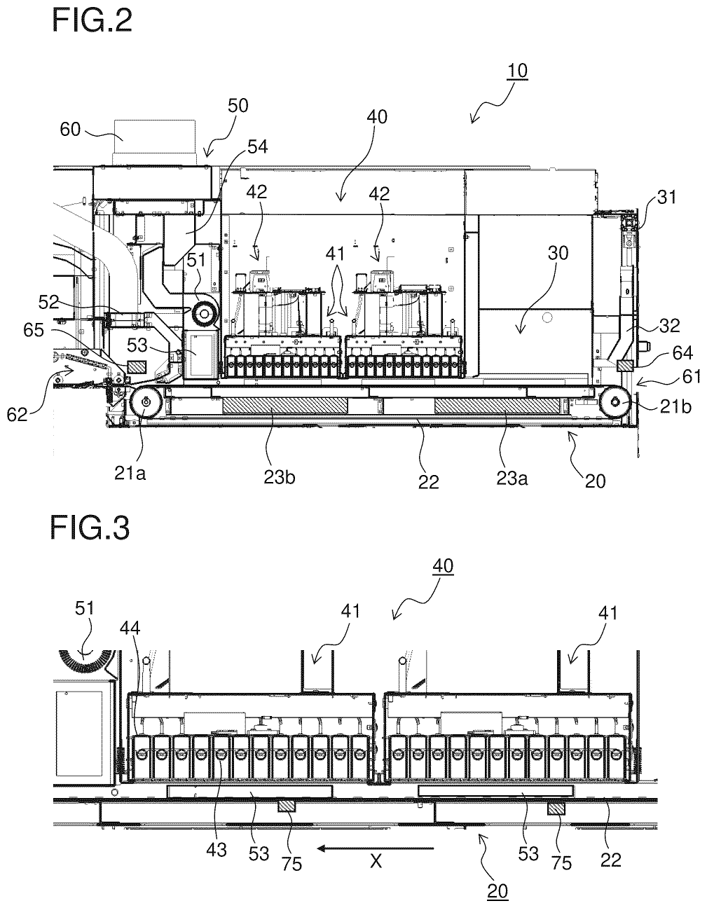

1. Construction of an Image Forming System Including a Sheet Drying Apparatus: An embodiment of the present disclosure will be described below with reference to the accompanying drawings. FIG. 1 is a schematic diagram showing the internal construction of an image forming system 200 including a sheet drying apparatus 10 of the present disclosure. FIG. 2 is a side sectional view around a drying portion 40 in the sheet drying apparatus 10 according to one embodiment of the present disclosure. With reference to FIGS. 1 and 2, the image forming system 200 configured with an image forming apparatus 100 and the sheet drying apparatus 10 will be described.

The image forming apparatus 100 is an inkjet recording printer and includes a sheet storage portion 2 arranged in a bottom part of the image forming apparatus 100, an image forming portion 3 arranged above the sheet storage portion 2, and a sheet feed portion 4 that feeds a sheet P stored in the sheet storage portion 2 to the image forming portion 3.

The image forming portion 3 is configured with a recording portion 3a having a plurality of recording heads and a print conveyance portion 3b arranged opposite the recording portion 3a. The print conveyance portion 3b includes an endless print conveyance belt 5 stretched around a plurality of rollers including a driving roller. The sheet P conveyed by the sheet feed portion 4 is conveyed below the recording portion 3a by being held under suction on the print conveyance belt 5 by a sheet suction portion (not shown) arranged inward of the print conveyance belt 5. The sheet P having a predetermined image recorded to it by the image forming portion 3 is discharged through a pair of discharge rollers 6 and is conveyed into the sheet drying apparatus 10.

The image forming apparatus 100 includes an operation panel 101 and a main unit controller 102. The operation panel 101 is an operation portion for accepting the input of various settings. For example, a user can operate the operation panel 101 to enter information on the size of sheets. The user can also operate the operation panel 101 to enter the number of sheets to be printed and to enter an instruction to start a print job. The main unit controller 102 coordinates the operation of the entire image forming apparatus 100 and controls different blocks in the image forming apparatus 100.

The sheet drying apparatus 10 is arranged adjacent to the image forming apparatus 100 and dries the ink on the sheet P discharged from the image forming apparatus 100. The sheet drying apparatus 10 includes a first conveyance portion 20, a preliminary drying portion 30, a drying portion 40, a suction fan unit 50, and a second conveyance portion 70.

The first conveyance portion 20 includes a driving roller 21a, a driven roller 21b, and a conveyance belt 22. The conveyance belt 22 is stretched around the driving roller 21a arranged on the downstream side and the driven roller 21b arranged on the upstream side with respect to the conveyance direction of the sheet P (right to left direction in FIG. 1; hereinafter, referred to simply as the conveyance direction).

Inward of the conveyance belt 22 are arranged sheet suction portions 23a and 23b. In the conveyance belt 22, many suction holes (not shown) are formed through which to pass suction air for sucking the sheet P onto the conveyance belt 22 by negative pressure suction by the sheet suction portions 23a and 23b.

Belt cooling fans 24 are arranged at two places below the conveyance belt 22. A belt temperature sensor 25 is arranged at an interval from the bottom face of the conveyance belt 22. The belt cooling fan 24 blows cooling air to the conveyance belt 22 when the sensed temperature of the belt temperature sensor 25 reaches or exceeds a predetermined temperature.

The preliminary drying portion 30 is arranged closely downstream of a sheet loading port 61 with respect to the conveyance direction and preliminarily dries the ink on the sheet P conveyed in through the sheet loading port 61. The preliminary drying portion 30 includes a sheet blowing fan 31 and a sheet blowing duct 32 for blowing air from above the sheet P.

The drying portion 40 is arranged adjacently downstream of the preliminary drying portion 30 with respect to the conveyance direction and dries the ink on the sheet P having passed through the preliminary drying portion 30. The drying portion 40 includes two heating units 41 arranged so as to face the top surface of the conveyance belt 22.

The suction fan unit 50 sucks in the water vapor emanating from the sheet P passing through the drying portion 40. The suction fan unit 50 includes a suction fan 51 that sucks in air containing water vapor inside the drying portion 40 and a separation fan 52 that blows separation air for separating the sheet P from the conveyance belt 22. The suction fan unit 50 communicates with a space between the conveyance belt 22 and the heating unit 41 via a first duct 53 and communicates with an exhausting port 60 formed in a top part of the sheet drying apparatus 10 via a second duct 54.

A plurality of ambient air intake fans 63 for taking in ambient air into the sheet drying apparatus 10 are arranged at appropriate places in the sheet drying apparatus 10. In an upstream and a downstream part of the first conveyance portion 20 are arranged sheet detection sensors 64 and 65 respectively. The sheet detection sensors 64 and 65 detect the sheet P having passed through the sheet loading port 61 and the sheet discharge port 62.

As, by being driven to rotate by the driving roller 21a, the conveyance belt 22 rotates in the counterclockwise direction, the sheet P conveyed in through the sheet loading port 61 passes through the preliminary drying portion 30 and then through the drying portion 40 to be discharged through the sheet discharge port 62 out of the sheet drying apparatus 10 or conveyed into the second conveyance portion 70.

The second conveyance portion 70 is arranged below the drying portion 40 and the preliminary drying portion 30 across the first conveyance portion 20. The second conveyance portion 70 includes a reversing conveyance passage 70a, for reversing top side down the sheet P on which the ink has been dried, and a duplex conveyance passage 70b, for returning, when duplex printing is performed on the sheet P, the sheet P reversed top side down to the image forming apparatus 100.

Downstream (left side in FIG. 1) of the suction fan unit 50 with respect to the conveyance direction is provided a retraction path 71 in the shape of an arc. The retraction path 71 is where a sheet P (waste sheet) that has become useless due to a printing defect or the like in the image forming apparatus 100 is retracted and stored.

2. Construction of the Sheet Drying Apparatus: FIG. 3 is an enlarged view of the drying portion 40 in FIG. 2. The drying portion 40 includes a heating unit 41 and a hot air fan 42 (see FIG. 2). Two heating units 41 are arranged along the conveyance direction (arrow-X direction). The heating unit 41 includes a heater 43 and a reflector 44. The heating unit 41 is movable between a heating position opposite the conveyance belt 22 (the position in FIG. 3) and a retracted position away from the conveyance belt 22 (see FIG. 10).

The heater 43 is in the shape of a bar extending in the sheet width direction (the direction orthogonal to the plane in FIG. 3; hereinafter, referred to simply as the width direction) horizontally orthogonal to the conveyance direction. In the heating unit 41, a plurality (12 in this embodiment) of heaters 43 are arranged side by side along the conveyance direction. In this embodiment, an infrared heater is used as the heater 43.

The reflector 44 is a reflector plate that is U-shaped as seen in a side view and that is arranged so as to surround the heater 43 from above. The infrared rays emitted from the heater 43 are reflected downward by the inner surface of the reflector 44 and are shone onto the sheet P carried and conveyed on the conveyance belt 22. Thus, the moisture in the ink on the sheet P evaporates and the ink dries; thus, the ink is fixed to the sheet P.

The hot air fan 42 is arranged above the heating unit 41. More specifically, the hot air fan 42 is arranged so as to blow air from above toward the reflectors 44. The air blown from the hot air fan 42 onto the reflectors 44 is heated as it passes through the gaps between the reflectors 44 and become hot air to flow into the gap (drying space) between the heating unit 41 and the conveyance belt 22.

If steam or water vapor is present in the gap between the heating unit 41 and the conveyance belt 22, the infrared rays emitted from the heater 43 and reflected from the reflector 44 are absorbed by the steam or water vapor and this impairs the ability to dry the ink on the sheet P. Thus, by operating the hot air fan 42 to blow hot air into the gap between the heating unit 41 and the conveyance belt 22 and scattering and removing the steam or water vapor emanating from the sheet P, it is possible to maintain the drying properties of the ink under infrared rays.

Between the drying portion 40 and the suction fan unit 50, a first duct 53 is provided for sucking the steam or water vapor emanating from the sheet P together with air. The first duct 53 extends from the gap between the heating unit 41 and the conveyance belt 22 to the suction fan 51 in the suction fan unit 50.

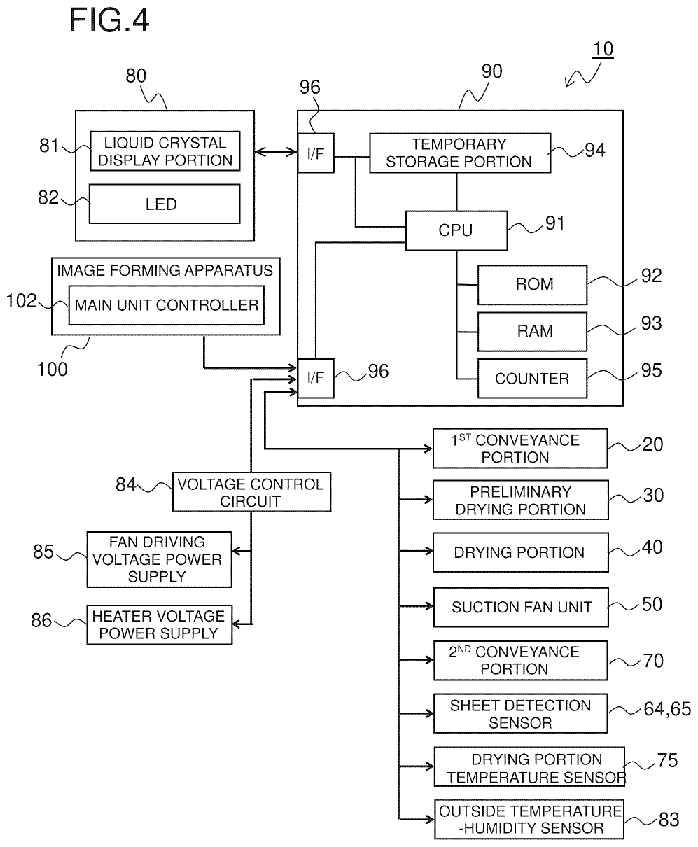

At each of two places facing the two heating units 41 in the drying portion 40, a drying portion temperature sensor 75 is arranged. The drying portion temperature sensor 75 senses the temperature inside the drying portion 40. The result of its sensing is transmitted to a control portion 90 (see FIG. 4).

FIG. 4 is a block diagram showing one example of control paths in the sheet drying apparatus 10 of the embodiment. For simplicity's sake, the following description will focus on those control paths in the sheet drying apparatus 10 that are necessary for implementing the present disclosure.

A control portion 90 at least includes a CPU (central processing unit) 91 as a central arithmetic processor, a ROM (read-only memory) 92 as a read-only storage portion, a RAM (random-access memory) 93 as a readable and rewritable storage portion, a temporary storage portion 94 that temporarily stores data required for controlling different parts of the sheet drying apparatus 10, and a plurality of (here, two) I/Fs (interfaces) 96 that transmit control signals to different blocks in the sheet drying apparatus 10 and receive input signals from an operation portion 80.

The ROM 92 stores a control program for the sheet drying apparatus 10 as well as data that are not changed during the use of the sheet drying apparatus 10, such as values necessary for control. The RAM 93 stores necessary data generated in controlling the sheet drying apparatus 10, data temporarily required in controlling the sheet drying apparatus 10, and the like. The RAM 93 (or the ROM 92) also stores, for use in controlling the duty of the heater 43, the relationship between the print ratio of the image formed on the sheet P and the duty of the heater 43 and the like. The counter 95 counts the cumulative number of sheets P that have been fed in.

The control portion 90 transmits control signals from the CPU 91 via the I/Fs 96 to different parts and blocks in the sheet drying apparatus 10. From those parts and blocks, signals indicating their states and input signals are transmitted via the I/Fs 96 to the CPU 91. Examples of the parts and blocks controlled by the control portion 90 include the first conveyance portion 20, the preliminary drying portion 30, the drying portion 40, the suction fan unit 50, the second conveyance portion 70, the sheet detection sensors 64 and 65, the operation portion 80, the drying portion temperature sensor 75, the voltage control circuit 84, and the like.

A voltage control circuit 84 is connected to a fan driving voltage power supply 85 and to a heater voltage power supply 86 and, according to output signals from the control portion 90, operates these power supplies. According to control signals from the voltage control circuit 84, the fan driving voltage power supply 85 applies a predetermined voltage to the belt cooling fan 24 in the conveyance portion 20, the hot air fan 42 in the heating unit 41 and the heater voltage power supply 86 applies a predetermined voltage to the heater 43 in the heating unit 41.

The operation portion 80 includes a liquid crystal display portion 81 and LEDs 82 that indicate various states. A user operates a stop/clear button on the operation portion 80 to stop the drying of the sheet P and operates a reset button on it to bring various settings for the sheet drying apparatus 10 back to default ones. The liquid crystal display portion 81 indicates the status of the sheet drying apparatus 10 and displays the progress of the drying of the sheet P and the number of sheets P that have been fed in. Various settings for the sheet drying apparatus 10 may be made via the operation panel 101 on the image forming apparatus 100 or from a personal computer.

An outside temperature-humidity sensor 83 senses the temperature and humidity outside the image forming apparatus 100. The result of its sensing is transmitted to the control portion 90. The outside temperature-humidity sensor 83 is arranged at a place where it is unlikely to be affected by the heat from the preliminary drying portion 30 and the drying portion 40 in the sheet drying apparatus 10.

3. Duty Adjustment for an AC Voltage Applied to the Heater: The drying performance (the radiation intensity of infrared rays) of the heater 43 necessary to dry a sheet P varies depending on the type, size, and thickness of the sheet P; it varies also depending on the amount of ink used in image recording on the image forming apparatus 100. Thus, it can be difficult to stably dry the sheet P solely through adjustment of the radiation intensity of infrared rays by turning the heater 43 on and off.

As a solution, in the embodiment, the duty of the alternating-current voltage that is applied to the heater 43 is adjusted based on output information on the properties of the sheet P. Specifically, from the image forming apparatus 100, output information on the properties of the sheet P (the type, size, thickness, and print ratio of the sheet P) is fed in. According to the output information on the properties of the sheet P thus fed in, the control portion 90 changes the duty of the alternating-current voltage applied to the heater 43 from a default value (initially set value) to a predetermined adjusted set value.

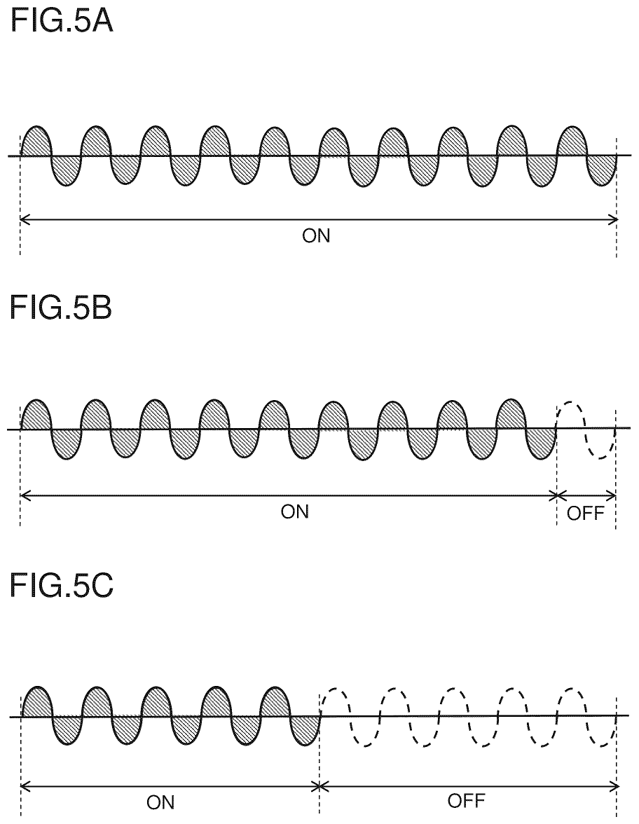

FIGS. 5A to 5C are schematic diagrams showing examples of the duty set for the waveform of the alternating-current voltage applied from the heater voltage power supply 86 to the heater 43. The heater 43 is controlled between on and off in cycles of 20 waves starting at a zero-cross point while the number of waves is reduced through control of the duty. For example, with a 50 Hz power supply, one cycle equals 200 [ms].

FIG. 5A shows the waveform at a duty of 100%; the number of waves is not reduced and so the on period lasts for 20 waves out of 20 waves (100%). FIG. 5B shows the waveform at a duty of 90%; two waves out of 20 waves are suppressed as an off period and so the on period lasts for 18 waves out of 20 waves (90%). FIG. 5C shows the waveform at a duty of 50%; 10 waves out of 20 waves are suppressed as an off period and so the on period lasts for 10 waves out of 20 waves (90%).

The duty of the alternating-current voltage applied to the heater 43 is set according to the type, size, thickness, print ratio (the proportion of the area where ink is adhered in the total surface area) of the sheet P. For example, when the sheet P is offset-coat paper, which is more difficult to dry than regular paper, if the print ratio is low (less than 30%), the duty is et to 50%. If the print ratio is within the range of 30% to 100% of the maximum load capacity of the image forming apparatus 100, the duty is set according to that percentage.

When the sheet P is regular paper, if the print ratio is low (less than 30%) and the sheet P can be dried without the heater 43 on, the duty is set to 0%. If the print ratio is within the range of 30% to 100% of the maximum load capacity of the image forming apparatus 100, the duty is set to 50%.

It is also possible to adjust the duty of the waveform of the alternating-current voltage applied to the heater 43 according to the temperature and humidity conditions outside or inside the sheet drying apparatus 10. For example, in high-temperature low-humidity conditions, the sheet P is easy to dry, and thus the duty is changed to an adjusted set value lower than the default value (initially set value). In low-temperature high-humidity conditions, the sheet P is difficult to dry, and thus the duty is changed to an adjusted set value higher than the default value (initially set value). Table 1 shows an example of how the duty is set.

TABLE 1

| Menu-Set Value | 1 | 2 | 3 | 4 | 5 | 6 | 7 |
|---|---|---|---|---|---|---|---|
| Duty [%] | 0 | 50 | 60 | 70 | 80 | 90 | 100 |

In the example shown in Table 1, menu-set values 1 to 7 are assigned to different set values of the duty of the alternating-current voltage applied to the heater 43, menu-set value 2 (duty 50%) being the default value (initial setting). The duty can be set in seven steps of 0%, 50%, 60%, 70%, 80%, 90%, and 100%, increasingly large set values corresponding to increasingly large menu-set values.

The setting of the duty of the alternating-current voltage applied to the heater 43 can be done manually or automatically. Manual setting is achieved by a user selecting a menu-set value and thereby selecting a desired adjusted set value by using the operation portion 80 of the sheet drying apparatus 10. By manual setting, the user can select the desired duty to suit varying kinds of sheet and ink and varying print ratios (amounts of ink adhered) and thereby cope flexibly with different kinds of sheet and ink.

Automatic setting is achieved by the control portion 90 selecting an optimal adjusted set value based on the output information on the properties of the sheets P (the type, size, thickness, and print ratio of the sheet P) transmitted from the image forming apparatus 100. Automatic setting eliminates the need for a user to change the settings through test printing and test drying and helps reduce working time.

When the duty is set manually, it is preferable to change the duty of the alternating-current voltage applied to the heater 43 from the adjusted set value to the initially set value automatically after the completion of a job. This eliminates the risk, at the start of a new job (drying process), of the job being performed with the adjusted set value used in the previous job.

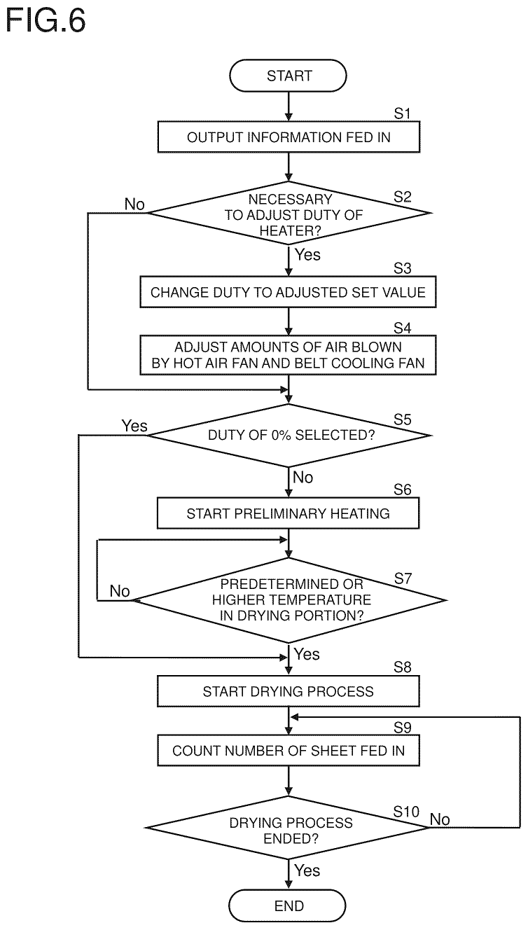

FIG. 6 is a flow chart showing an example of control for adjusting the duty of the heater 43 in the sheet drying apparatus 10. With reference to FIGS. 1 to 5 as necessary, along the steps in FIG. 6, a control procedure for automatic adjustment of the duty of the alternating-current voltage applied to the heater 43 will be described. It is here assumed that in the initial state the duty of the heater 43 is set to the initial set value (e.g., 50%). In the following description, output information on the properties of the sheet P is occasionally referred to simply as output information on the sheet P.

When a command to print on the sheet P is fed in from the main unit controller 102 in the image forming apparatus 100, output information on the sheet P is, along with a command to start drying the sheet P, fed to the control portion 90 in the sheet drying apparatus 10 (Step S1). Out of the output information on the sheet P, information on the type of the sheet P, such as the size, thickness, surface smoothness, and the like of the sheet P, is entered from the operation panel 101 (see FIG. 1) on the image forming apparatus 100. For example, the manufacturer, product name, article number, and the like of the sheet P can be, in association with the information on the type of the corresponding sheet P, previously stored in the main unit controller 102. With this, the user can simply select the manufacturer, product name, article number, and the like of the sheet P on the operation panel 101 to make the main unit controller 102 recognize the information on the type of the sheet P to be used.

Information on the print ratio of the sheet P is calculated by the main unit controller 102 based on image data transmitted from a host device such as a personal computer and is fed to the control portion 90.

Based on the output information on the sheet P thus fed in, the control portion 90 judges whether it is necessary to adjust the duty of the alternating-current voltage applied to the heater 43 (Step S2). If it is judged that duty adjustment is necessary (Step S2, Yes), the control portion 90 changes the duty of the alternating-current voltage applied to the heater 43 from the initial set value to an adjusted set value (Step S3).

For example, as the size or thickness of the sheet P increases, the amount of heat necessary to dry it increases. Likewise, if the sheet P is coated paper with high surface smoothness, ink is more difficult to dry than on regular paper and thus drying the sheet P requires an increased amount of heat. Accordingly, if the sheet P is large size or thick, or if the sheet P is coated paper, the duty is set to an adjusted set value larger than the initial set value.

By contrast, if the sheet P is small size or thin, or if the sheet P is regular paper, the duty is set to an adjusted set value smaller than the initial set value. The amount by which to adjust the duty from the initial set value is determined based on a table that defines the relationship of the type, size, and thickness of the sheet P with the corresponding duty.

On the other hand, as the print ratio on the sheet P increases, the amount of moisture on the sheet P increases, and thus the amount of heat needed to dry the sheet P increases. Accordingly, if the print ratio is higher than a reference print ratio (e.g., 30%), the duty is set to an adjusted set value larger than the initial set value. By contrast, if the print ratio is lower than the reference print ratio, the duty is set to an adjusted set value smaller than the initial set value. The amount by which to adjust the duty from the initial set value is determined based on a table that defines the relationship of the print ratio with the corresponding duty.

The adjustment of the duty of the alternating-current voltage applied to the heater 43 is accompanied by the adjustment of the amounts of air blown by the hot air fan 42 and the belt cooling fan 24 (Step S4). For example, in a case where the duty is set to an adjusted set value larger than the initial set value, to increase the drying performance for the sheet P, the amount of air blown by the hot air fan 42 is increased. On the other hand, to use the heat of the conveyance belt 22 to dry the sheet P, the amount of air blown by the belt cooling fan 24 is reduced. In a case where the duty is set to an adjusted set value smaller than the initial set value, to reduce power consumption, the amount of air blown by the hot air fan 42 is reduced.

If it is judged that duty adjustment is not necessary (Step S2, No), without either changing the duty from the initial set value or adjusting the amounts of air blown by the hot air fan 42 and the belt cooling fan 24, the control portion 90 advances to the next step.

Next, the control portion 90 checks whether at Step S3 a duty of 0% has been selected (Step S5). If a duty of 0% has not been selected (Step S5, No), the control portion 90 turns on the heater 43 and starts preliminary heating (Step S6). Here, the alternating-current voltage is applied to the heater 43 by use of the adjusted set value set at Step S3.

Next, based on the result of sensing by the drying portion temperature sensor 75, the control portion 90 checks whether the temperature in the drying portion 40 has become equal to or higher than a predetermined temperature (Step S7). If the temperature in the drying portion 40 has become equal to or higher than the predetermined temperature (Step S7, Yes). the image forming apparatus 100 starts a printing process for the sheet P and the sheet drying apparatus 10 starts a drying process for the sheet P (Step S8). If at Step S5 a duty of 0% has been selected (Step S5, Yes), then immediately, with the heater 43 kept off, the image forming apparatus 100 starts a printing process for the sheet P and the sheet drying apparatus 10 starts a drying process for the sheet P (Step S8).

Based on a sensing signal from the sheet detection sensor 64, the control portion 90 counts, with the counter 95, the number of sheets P fed into the sheet drying apparatus 10 (Step S9). The control portion 90 checks whether a predetermined number of sheets P have been fed in and the drying process has ended (Step S10).

If the drying process still continues (Step S10, No), a return is made to Step S9, where the counting of the number of sheets fed in is continued. If the drying process has ended (Step S10, Yes), the heater 43 is turned off and the procedure is ended.

In the example of control shown in FIG. 6, based on the output information on the sheet P, the duty of the alternating-current voltage applied to the heater 43 is changed to an adjusted set value. It is thus possible to dry the sheet P stably without being affected by the type, size, thickness, or print ratio of the sheet P, and moreover to cut down unnecessary power consumption.

When the duty of the alternating-current voltage applied to the heater 43 is adjusted, by changing not only the duty but also the amounts of air blown by the hot air fan 42 and the belt cooling fan 24, it is possible to more efficiently dry the sheet P and reduce power consumption.

Preliminarily heating the drying portion 40 by use of an adjusted set value of the duty provides the following benefits: if the duty is set to an adjusted set value smaller than the initial set value, overheating of the drying portion 40 can be prevented; if the duty is set to an adjusted set value larger than the initial set value, the start-up time of the drying portion 40 can be reduced.

In the example of control shown in FIG. 6, the adjustment of the duty of the alternating-current voltage applied to the heater 43 (Step S3) is accompanied by the adjustment of the amounts of air blown by the hot air fan 42 and the belt cooling fan 24 (Step S4). Instead, the adjustment of the duty can be accompanied by the adjustment of the amount of air blown by either of the hot air fan 42 and the belt cooling fan 24, or only the duty can be adjusted with no adjustment made with the amounts of air blown by the hot air fan 42 and the belt cooling fan 24.

In the example of control shown in FIG. 6, based on output information on the sheet P, the duty of the alternating-current voltage applied to the heater 43 is adjusted. Instead, the duty can be adjusted based on the temperature and humidity conditions outside the sheet drying apparatus 10 as sensed by the outside temperature-humidity sensor 83.

For example, based on the result of sensing by the outside temperature-humidity sensor 83, if the conditions outside are judged to be high-temperature low-humidity conditions, the sheet P is easy to dry, and thus the control portion 90 can change the duty to an adjusted set value smaller than the initial set value and, if the conditions outside are judged to be low-temperature high-humidity conditions, the sheet P is difficult to dry, and thus the control portion 90 can change the duty to an adjusted set value larger than the initial set value.

A configuration is also possible that allows the changing of the initial set value of the duty. For example, in a case where only high-print-ratio printing is performed on the image forming apparatus 100, or where only coated paper is used as the sheet P, the initial set value of the duty can be previously set to 60% to 100%. This reduces the frequency of control being performed for automatic adjustment of the duty, and helps alleviate the control load on the control portion 90.

The above embodiment is not meant to limit the scope of the present disclosure, which can thus be implemented with any modifications made without departure from the spirit of the present disclosure. For example, while the above embodiment deals with, as an example of an image forming system, a configuration where the sheet drying apparatus 10 is coupled to an inkjet printer as the image forming apparatus 100, needless to say, the sheet drying apparatus 10 can be used independently without being coupled to the image forming apparatus 100.

The present disclosure finds applications in sheet drying apparatuses that dry sheets having images printed on them by an inkjet recording apparatus or the like. Based on the present disclosure, it is possible to provide a sheet drying apparatus of which the drying performance can be set to suit the properties of sheets as the drying target, and to provide an image forming system provided with such a sheet drying apparatus.

What is claimed is:

1. A sheet drying apparatus comprising:
a conveyance portion that conveys a sheet having an image formed thereon with ink containing moisture;
a drying portion including a heater arranged opposite the conveyance portion, the drying portion heating and drying the sheet by using the heater;
a heater voltage power supply that applies an alternating-current voltage to the heater; and
a control portion that controls the heater voltage power supply,
wherein
the control portion is operable to change a duty of the alternating-current voltage applied to the heater from an initial set value to an adjusted set value.

2. The sheet drying apparatus according to claim 1, wherein
the control portion changes the duty from the initial set value to the adjusted set value automatically based on output information on a property of the sheet.

3. The sheet drying apparatus according to claim 2, wherein
the output information on the property of the sheet includes at least one of a type, a size, a thickness, a print ratio of the sheet.

4. The sheet drying apparatus according to claim 1, further comprising:
a temperature-humidity sensor that senses temperature and humidity outside or inside the sheet drying apparatus,
wherein
the control portion changes the duty from the initial set value to the adjusted set value automatically based on the temperature and the humidity sensed by the temperature-humidity sensor.

5. The sheet drying apparatus according to claim 1, further comprising:
an input portion that selects as the adjusted set value one of a plurality of duties,
wherein
when the input portion selects as the adjusted set value one of the plurality of duties, the control portion changes the duty of the alternating-current voltage applied to the heater to the adjusted set value.

6. The sheet drying apparatus according to claim 5, wherein
when the input portion selects as the adjusted set value one of the plurality of duties and a drying process for the sheet is performed with the alternating-current voltage applied to the heater by use of the selected adjusted set value, the control portion changes the duty from the adjusted set value back to the initial set value after the drying process is performed.

7. The sheet drying apparatus according to claim 5, wherein
the input portion is operable to select as the initial set value one of the plurality of duties.

8. The sheet drying apparatus according to claim 1, wherein
the control portion is operable to perform, before the drying process for the sheet is performed, preliminary heating to apply the alternating-current voltage to the heater to heat the drying portion to or above a predetermined temperature, and
when the duty is changed from the initial set value to the adjusted set value, the control portion performs the preliminary heating by applying the alternating-current voltage to the heater by use of the adjusted set value.

9. The sheet drying apparatus according to claim 8, wherein
if the adjusted set value is 0%, the control portion performs the drying process without performing the preliminary heating.

10. The sheet drying apparatus according to claim 1, wherein
the drying portion includes:
a heating unit having:
a plurality of the heaters that are infrared heaters; and
a plurality of reflectors that surround the heaters from a direction opposite from the conveyance portion; and
a hot air fan arranged opposite the conveyance portion across the heating unit, the hot air fan blowing toward the conveyance portion hot air resulting from air passing through a gap between the reflectors,
wherein
when the duty is changed to the adjusted set value, the control portion changes an amount of air blown by the hot air fan according to the adjusted set value.

11. The sheet drying apparatus according to claim 1, wherein
the conveyance portion includes:
a conveyance belt that conveys the sheet in a state sucked thereon; and
a belt cooling fan that cools the conveyance belt,
wherein
when the duty is changed to the adjusted set value, the control portion changes an amount of air blown by the belt cooling fan according to the adjusted set value.

12. An image forming system comprising:
an image forming apparatus that forms an image on a sheet by using ink containing moisture; and
the sheet drying apparatus according to claim 1 coupled to the image forming apparatus at a downstream side thereof with respect to a conveyance direction of the sheet, the sheet drying apparatus drying the sheet having the image formed by the image forming apparatus.
